(19) United States
(12) Patent Application Publication
(10) Pub. No.: US 2019/0148981 A1
(43) Pub. Date: May 16, 2019

(54) WIRELESS CHARGING CIRCUIT, WIRELESS CHARGING SYSTEM, AND CIRCUIT CONTROL METHOD

(71) Applicant: HUAWEI TECHNOLOGIES CO., LTD., Shenzhen (CN)

(72) Inventor: Yunhe MAO, Shenzhen (CN)

(21) Appl. No.: 16/246,372

(22) Filed: Jan. 11, 2019

Related U.S. Application Data
(63) Continuation of application No. PCT/CN2017/071799, filed on Jan. 20, 2017.

(30) Foreign Application Priority Data
Jul. 15, 2016 (CN) 201610567324.2

(51) Int. Cl. H02J 50/12; H02J 50/80; H02J 7/02; H02J 7/04; H04B 5/00

(52) U.S. Cl. CPC H02J 50/12; H02J 50/80; H04B 5/0037; H02J 7/045; H02J 7/025

(57) ABSTRACT

A wireless charging circuit includes a DC/AC converter, a wireless transmitter, a control component, and a wireless communications component. The wireless communications component is configured to receive charging parameters fed back by a receive end, the control component is configured to send a first drive signal or a second drive signal to the DC/AC conversion module based on the charging parameters, and the DC/AC converter is configured to be in a working state under control of the first drive signal, and convert a direct current voltage in the working state or be in a non-working state under control of the second drive signal, and skip converting a direct current voltage in the non-working state.

### CROSS-REFERENCE TO RELATED APPLICATIONS

This application is a continuation of International Application No. PCT/CN2017/071799, filed on Jan. 20, 2017, which claims priority to Chinese Patent Application No. 201610567324.2, filed on Jul. 15, 2016. The disclosures of the aforementioned applications are hereby incorporated by reference in their entireties.

### TECHNICAL FIELD

The present application relates to the field of wireless charging technologies, and in particular, to a wireless charging circuit, a wireless charging system, and a circuit control method.

### BACKGROUND

Wireless charging means that a battery-equipped receive end obtains electric power from a transmit end through electromagnetic wave induction, where the transmit end generates an electromagnetic signal, and the receive end senses the electromagnetic signal and generates a current to charge a battery.

Due to different capacities of batteries that need to be charged, an output power of the transmit end and an output power of the receive end need to be adjusted based on a load. In a common output power adjustment method, an impedance matching circuit is added to each of the transmit end and the receive end, capacitance is adjusted by using an adjustable capacitor in the impedance matching circuit, and inductance is adjusted by using an adjustable inductor in the impedance matching circuit, so as to adjust the output power. In one embodiment, a controllable switch in the adjustable capacitor is connected to a capacitor in series, and whether the capacitor is connected is controlled by turning on or off the controllable switch, so as to adjust the capacitance. A mechanical apparatus or an additional regulation circuit is added to the adjustable inductor, and the inductance is adjusted by changing a bias voltage.

In the foregoing output power adjustment method, if a power electronic device is used as the controllable switch to adjust the capacitance, a conduction loss is large and efficiency is low; and if a relay is used as the controllable switch to adjust the capacitance, impact resistance is limited. Moreover, using a mechanical structure to adjust the inductance increases circuit costs and a volume. In addition, in the foregoing output power adjustment method, the output power can be adjusted only after the additional circuit is added to a system. This not only increases circuit costs and a volume, but also reduces system efficiency and power density.

### SUMMARY

To resolve the problem in the prior art, embodiments of the present application provide a wireless charging circuit, a wireless charging system, and a circuit control method. The technical solutions are as follows:

According to a first aspect, a wireless charging circuit is provided, where the wireless charging circuit is applied to a transmit end in a wireless charging system, and includes a direct current (DC)/alternating current (AC) converter connected to a power source, a wireless transmitter and a control component each connected to the DC/AC converter, and a wireless communications component connected to the control component. The power source is configured to provide a direct current voltage. The wireless communications component is configured to receive charging parameters fed back by a receive end in the wireless charging system, where the charging parameters are used to represent a difference between an actual charging parameter and a required charging parameter. The control component is configured to generate, based on the charging parameters, a first drive signal that lasts for first duration, and send the first drive signal to the DC/AC converter; or generate, based on the charging parameters, a second drive signal that lasts for second duration, and send the second drive signal to the DC/AC converter. The DC/AC converter is configured to be in the working state in the first duration under control of the first drive signal, and convert the direct current voltage into a high-frequency alternating current voltage in the working state; or be in a non-working state in the second duration under control of the second drive signal, and skip converting the direct current voltage in the non-working state. The wireless transmitter is configured to convert, into the high-frequency magnetic field, the high-frequency alternating current voltage that is obtained through conversion when the DC/AC converter is in the working state, and transmit the high-frequency magnetic field, where the high-frequency magnetic field is used to charge the battery component.

The transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the transmit end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

With reference to the first aspect, in one embodiment of the first aspect, the control component includes a modulation generation component, and the DC/AC converter is a bridge-structure circuit including switching transistors; and the modulation generation component is configured to send the first drive signal that lasts for the first duration to the DC/AC converter, where when the DC/AC converter switches from the non-working state to the working state under control of the first drive signal, a fundamental wave of the high-frequency alternating current voltage and a phase-shift angle between voltages of a front bridge arm and a rear bridge arm of the DC/AC converter linearly increase from zero to a pre-determined value, where the pre-determined value is an angle that enables the DC/AC converter to implement soft switching; or the modulation generation component is configured to send the second drive signal that lasts for the second duration to the DC/AC converter, where when the DC/AC converter switches from the working state to the non-working state under control of the second drive signal, a fundamental wave of the high-frequency alternating current voltage and a phase-shift angle between voltages of a front bridge arm and a rear bridge arm of the DC/AC converter linearly decrease from a pre-determined value to zero, where the pre-determined value is an angle that enables the DC/AC converter to implement soft switching.

When the DC/AC converter switches between the working state and the non-working state, a current keeps linearly increasing or linearly decreasing, so that impact on the wireless charging system in a switching process is reduced, the switching process is quickened, and a loss in the switching process is reduced. In addition, when the DC/AC converter implements soft switching, the average power of the actual load of the receive end is greater than the required power of the load. Therefore, the DC/AC converter switches between the working state and the non-working state, so that the average power of the actual load of the receive end is equal to or close to the required power of the load when the DC/AC converter implements soft switching.

With reference to the first aspect, in one embodiment of the first aspect, a quotient of the first duration divided by the second duration is equal to a quotient of a required power of load of the receive end divided by an actual power that is of the receive end when the DC/AC converter is in the working state, where the required power is a power that is required by the load in a charging process. The duration of the drive signal of the DC/AC converter of the transmit end is associated with the power of the receive end, so that when the DC/AC converter intermittently works, the output power of the wireless charging system meets the power that is required by the load in the charging process.

With reference to the first aspect, in one embodiment, the charging parameters include a required voltage value, a required current value, a sampled current value, and a sampled voltage value, and the required voltage value is a voltage value that is required by the load of the receive end in the charging process; the control component includes a calculation component and the modulation generation component, and the modulation generation component is any one of a pulse width modulation (Pulse Width Modulation, PWM) control component, a frequency modulation control component, and a phase-shift control component; the calculation component is configured to generate a first control instruction based on the charging parameters when the required voltage value is less than the sampled voltage value or the required current value is less than the sampled current value; or generate a second control instruction based on the charging parameters when the required voltage value is greater than the sampled voltage value or the required current value is greater than the sampled current value; and the modulation generation component is configured to generate the first drive signal according to the first control instruction, and send the first drive signal to the DC/AC converter; or is configured to generate the second drive signal according to the second control instruction, and send the second drive signal to the DC/AC converter.

In one embodiment, the DC/AC converter includes four switching transistors; when a first switching transistor and a fourth switching transistor are in a first state, and a second switching transistor and a third switching transistor are in a second state, the DC/AC converter is in the working state; when the first switching transistor and the third switching transistor are in the first state, and the second switching transistor and the fourth switching transistor are in the second state, the DC/AC converter is in the non-working state; and the first state is an on state, and the second state is an off state; or the first state is an off state, and the second state is an on state.

In one embodiment, the wireless charging circuit further includes a compensator, and the compensator is located between the DC/AC converter and the wireless transmitter; and the compensator is configured to compensate for the high-frequency alternating current voltage output by the DC/AC converter, and output the stable high-frequency alternating current voltage to the wireless transmitter. The compensator compensates for the high-frequency alternating current voltage, so that the wireless transmitter outputs the stable high-frequency alternating current voltage. In this way, the receive end can receive the stable high-frequency alternating current voltage.

According to a second aspect, a wireless charging circuit is provided, where the wireless charging circuit is applied to a receive end in a wireless charging system, and includes a wireless receiver, an AC/DC converter connected to the wireless receiver, a controller, and a wireless communications component connected to the controller. The wireless receiver is configured to receive a high-frequency magnetic field transmitted by a transmit end in the wireless charging system, and convert the high-frequency magnetic field into a high-frequency alternating current voltage. The AC/DC converter is configured to convert the high-frequency alternating current voltage into a direct current voltage, to charge a connected battery component. The controller is configured to receive charging parameters that are generated by a battery management component based on a battery status of the battery component, and send the charging parameters to the wireless communications component, where the battery management component is connected to the battery component. The wireless communications component is configured to feed back the charging parameters to the transmit end, where the charging parameters are used to represent a difference between an actual charging parameter and a required charging parameter.

The transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

With reference to the second aspect, in one embodiment, the charging parameters include a required voltage value, a required current value, a sampled current value, and a sampled voltage value, the required voltage value is a voltage value that is required by load of the receive end in a charging process, and the required current value is a current value that is required by the load of the receive end in the charging process.

In one embodiment, the AC/DC converter is a rectifier bridge circuit including diodes; or the AC/DC converter is a synchronous rectification circuit including complementary metal oxide semiconductor (Complementary Metal Oxide Semiconductor, CMOS) transistors.

In one embodiment, the wireless charging circuit further includes a compensator, and the compensator is located between the wireless receiver and the AC/DC converter; and the compensator is configured to compensate for the direct current voltage output by the AC/DC module, and output the stable direct current voltage to the battery component. The compensator compensates for the high-frequency alternating current voltage, so that the wireless transmitter outputs the stable high-frequency alternating current voltage. In this way, the receive end can receive the stable high-frequency alternating current voltage.

In one embodiment, the wireless charging circuit further includes a filter, and the filter is located behind the AC/DC converter; and the filter is configured to remove a high-frequency voltage from the direct current voltage. The filter removes the high-frequency voltage from the direct current voltage, to ensure that there is no high-frequency voltage in the direct current voltage used for charging of a charging module, thereby preventing the battery component from being damaged.

According to a third aspect, a wireless charging system is provided, where the system includes a power source, a transmit end connected to the power source, a receive end, a battery component connected to the receive end, and a battery management component connected to both the battery component and the receive end. The transmit end includes the wireless charging circuit provided in at least one of the first aspect or the embodiments of the first aspect; and the receive end includes the wireless charging circuit provided in at least one of the second aspect or the embodiments of the second aspect.

According to a fourth aspect, a wireless charging circuit control method is provided, where the method is applied to the wireless charging circuit provided in at least one of the first aspect or the implementations of the first aspect, and the method includes: receiving, by using the wireless communications component, charging parameters fed back by a receive end in the wireless charging system, where the charging parameters are used to represent a difference between an actual charging parameter and a required charging parameter; generating, based on the charging parameters by using a control component, the first drive signal that lasts for the first duration, and sending the first drive signal to the DC/AC converter; or generating, based on the charging parameters by using a control component, the second drive signal that lasts for the second duration, and sending the second drive signal to the DC/AC converter; working in the working state in the first duration under control of the first drive signal by using the DC/AC conversion module, and converting the direct current voltage into the high-frequency alternating current voltage in the working state; or working in the non-working state in the second duration under control of the second drive signal by using the DC/AC conversion module, and skipping converting the direct current voltage in the non-working state; and converting, into the high-frequency magnetic field by using the wireless transmitter, the high-frequency alternating current voltage that is obtained through conversion when the DC/AC converter is in the working state, and transmitting the high-frequency magnetic field.

The transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

With reference to the fourth aspect, in one embodiment, the control component includes a modulation generation component, and the DC/AC converter is a bridge-structure circuit including switching transistors; and the method further includes: sending the first drive signal that lasts for the first duration to the DC/AC converter by using the modulation generation component, where when the DC/AC converter switches from the non-working state to the working state under control of the first drive signal, a fundamental wave of the high-frequency alternating current voltage and a phase-shift angle between voltages of a front bridge arm and a rear bridge arm of the DC/AC converter linearly increase from zero to a pre-determined value, where the pre-determined value is an angle that enables the DC/AC converter to implement soft switching; or sending the second drive signal that lasts for the second duration to the DC/AC converter by using the modulation generation component, where when the DC/AC converter switches from the working state to the non-working state under control of the second drive signal, a fundamental wave of the high-frequency alternating current voltage and a phase-shift angle between voltages of a front bridge arm and a rear bridge arm of the DC/AC converter linearly decrease from a pre-determined value to zero, where the pre-determined value is an angle that enables the DC/AC converter to implement soft switching. When the DC/AC converter switches between the working state and the non-working state, a phase-shift angle is enabled to linearly increase or decrease, and a current keeps linearly increasing or linearly decreasing, so that impact on the wireless charging system in a switching process is reduced, the switching process is quickened, and a loss in the switching process is reduced. In addition, when the DC/AC converter implements soft switching, the average power of the actual load of the receive end is greater than the required power of the load. Therefore, the DC/AC converter switches between the working state and the non-working state, so that the average power of the actual load of the receive end is equal to or close to the required power of the load when the DC/AC converter implements soft switching.

In one embodiment, a quotient of the first duration divided by the second duration is equal to a quotient of a required power of load of the receive end divided by an actual power that is of the receive end when the DC/AC converter is in the working state, where the required power is a power that is required by the load in a charging process.

The duration of the drive signal of the DC/AC converter of the transmit end is associated with the power of the receive end, so that when the DC/AC converter intermittently works, the output power of the wireless charging system meets the power that is required by the load in the charging process.

In one embodiment, the charging parameters include a required voltage value, a required current value, a sampled current value, and a sampled voltage value, and the required voltage value is a voltage value that is required by the load of the receive end in the charging process; the control component includes a calculation component and the modulation generation component, and the method further includes: generating a first control instruction based on the charging parameters by using the calculation component when the required voltage value is less than the sampled voltage value or the required current value is less than the sampled current value; or generating a second control instruction based on the charging parameters by using the calculation component when the required voltage value is greater than the sampled voltage value or the required current value is greater than the sampled current value; and generating the first drive signal according to the first control instruction by using the modulation generation component, and sending the first drive signal to the DC/AC converter; or generating the second drive signal according to the second control instruction by using the modulation generation component, and sending the second drive signal to the DC/AC converter.

In one embodiment, the wireless charging circuit further includes a compensator; and the method further includes: compensating, by using the compensator, for the high-frequency alternating current voltage output by the DC/AC converter, and outputting the stable high-frequency alternating current voltage to the wireless transmitter. The compensator compensates for the high-frequency alternating current voltage, so that the wireless transmitter outputs the stable high-frequency alternating current voltage. In this way, the receive end can receive the stable high-frequency alternating current voltage.

According to a fifth aspect, a wireless charging circuit control method is provided, where the method is applied to the wireless charging circuit provided in at least one of the second aspect or the embodiments of the second aspect, and the method includes: receiving, by using the wireless receiver, a high-frequency alternating current magnetic field transmitted by a transmit end in the wireless charging system, and converting the high-frequency magnetic field into a high-frequency alternating current voltage; converting the high-frequency alternating current magnetic field into a direct current voltage by using the AC/DC module, to charge a connected battery component; receiving, by using the controller, charging parameters that are generated by the battery management component based on a battery status of the battery component, and sending the charging parameters to the wireless communications component, where the battery management component is connected to the battery component; and feeding back the charging parameters to the transmit end by using the wireless communications component, where the charging parameters are used to represent a difference between an actual charging parameter and a required charging parameter.

The transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

With reference to the fifth aspect, in one embodiment, the charging parameters include a required voltage value, a required current value, a sampled voltage value, and a sampled current value, the required voltage value is a voltage value that is required by load of the receive end in a charging process, and the required current value is a current value that is required by the load of the receive end in the charging process.

In one embodiment, the wireless charging circuit further includes a compensator; and the method further includes: compensating, by using the compensator, for the direct current voltage output by the AC/DC module, and outputting the stable direct current voltage to the battery component. The compensator compensates for the high-frequency alternating current voltage, so that the wireless transmitter outputs the stable high-frequency alternating current voltage. In this way, the receive end can receive the stable high-frequency alternating current voltage.

In one embodiment, the wireless charging circuit further includes a filter; and the filter is configured to remove a high-frequency voltage from the direct current voltage. The filter removes the high-frequency voltage from the direct current voltage, to ensure that there is no high-frequency voltage in the direct current voltage used for charging of a charging module, thereby preventing the battery component from being damaged.

### BRIEF DESCRIPTION OF DRAWINGS

FIG. 1 is a schematic structural diagram of a wireless charging system according to an embodiment of the present application;

FIG. 2 is a schematic structural diagram of another wireless charging system according to an embodiment of the present application;

FIG. 3 is a schematic structural diagram of another wireless charging system according to an embodiment of the present application;

FIG. 4 is a schematic structural diagram of another wireless charging system according to an embodiment of the present application;

FIG. 5 is a schematic structural diagram of another wireless charging system according to an embodiment of the present application;

FIG. 6A and FIG. 6B are a flowchart of a wireless charging circuit control method according to an embodiment of the present application;

FIG. 7A-1 and FIG. 7A-2 are a flowchart of another wireless charging circuit control method according to an embodiment of the present application;

FIG. 7B is a flowchart of another wireless charging circuit control method according to an embodiment of the present application;

FIG. 8 is a schematic diagram of a relationship between a current of a transmit coil and a phase-shift angle before processing is performed according to an embodiment of the present application;

FIG. 9 is a schematic diagram of a relationship between a phase-shift angle and a time according to an embodiment of the present application; and

FIG. 10 is a schematic diagram of a relationship between a current of a transmit coil and a phase-shift angle after processing is performed according to an embodiment of the present application.

### DESCRIPTION OF EMBODIMENTS

To make the objectives, technical solutions, and advantages of the present application clearer, the following further describes the embodiments of the present application in detail with reference to the accompanying drawings.

A “module” mentioned in this specification is a program or an instruction that is stored in a memory and that can implement some functions. A “unit” mentioned in this specification is a functional structure divided based on logic. The “unit” may be implemented by only hardware, or implemented by a combination of software and hardware.

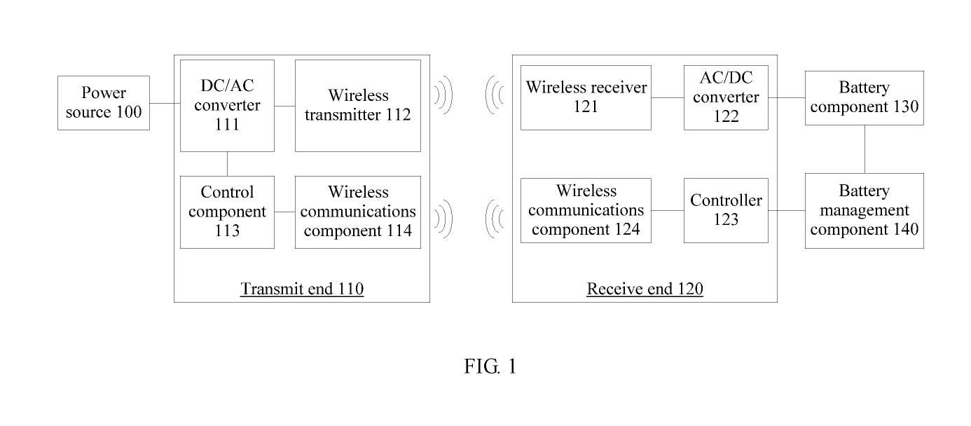

FIG. 1 is a schematic structural diagram of an example of a wireless charging system according to the present application. The wireless charging system includes a power source 100, a transmit end 110 connected to the power source, a receive end 120, a battery component 130 connected to the receive end 120, and a battery management component 140 connected to both the battery component 130 and the receive end 120.

The power source 100 is configured to provide a direct current voltage.

The transmit end 110 includes a direct current (, DC)/alternating current (, AC) converter 111, a wireless transmitter 112 connected to the DC/AC converter 111, a control component 113 connected to the DC/AC converter 111, and a wireless communications component 114 connected to the control component 113.

The wireless communications component 114 is configured to receive charging parameters fed back by the receive end 120 in the wireless charging system, where the charging parameters are used to represent a difference between an actual charging parameter and a required charging parameter. The actual charging parameter is a charging parameter that is actually obtained by the battery management component 140 in a charging process of the battery component 130. The required charging parameter is a charging parameter that is required by the battery component 130 in the charging process of the battery component 130.

The control component 113 is configured to generate, based on the charging parameters, a first drive signal that lasts for first duration, and send the first drive signal to the DC/AC converter 111; or generate, based on the charging parameters, a second drive signal that lasts for second duration, and send the second drive signal to the DC/AC converter 111.

The DC/AC converter 111 is in a working state in the first duration under control of the first drive signal, and converts the direct current voltage into a high-frequency alternating current voltage in the working state; or is in a non-working state in the second duration under control of the second drive signal, and skips converting the direct current voltage in the non-working state.

The wireless transmitter 112 is configured to convert, into a high-frequency magnetic field, the high-frequency alternating current voltage that is obtained through conversion when the DC/AC converter 111 is in the working state, and transmit the high-frequency magnetic field, where the high-frequency magnetic field is used to charge the battery component 130.

The receive end 120 includes a wireless receiver 121, an AC/DC converter 122 connected to the wireless receiver 121, a controller 123, and a wireless communications component 124 connected to the controller 123.

The wireless receiver 121 is configured to receive the high-frequency magnetic field transmitted by the transmit end 110 in the wireless charging system, and convert the high-frequency magnetic field into a high-frequency alternating current voltage.

The AC/DC converter 122 is configured to convert the high-frequency alternating current voltage into a direct current voltage, to charge the connected battery component 130.

The controller 123 is configured to receive the charging parameters that are generated by the battery management component 140 based on a battery status of the battery component 130, and send the charging parameters to the wireless communications component 124. The battery component 130 is connected to the battery management component 140.

The wireless communications component 124 is configured to feed back the charging parameters to the transmit end 110.

During charging of the battery component 130, the battery management component 140 detects the battery status, such as a voltage, a current, or temperature, of the battery component 130, and generates the charging parameters based on the detected battery status. The battery management component 140 sends the generated charging parameters to the controller 123 of the receive end 120.

To sum up, according to a wireless charging circuit provided in this embodiment of the present application, the transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

In one embodiment, the charging parameters include a required voltage value, a required current value, a sampled current value, and a sampled voltage value. The required voltage value is a voltage value that is required by load of the receive end in the charging process, for example, a voltage reference value in a constant-voltage charging mode. The required current value is a current value that is required by the load of the receive end in the charging process, for example, a current reference value in a constant-current charging mode, an average current, or a peak current. The sampled current value is a current that passes through the load, and is measured by a current sampling circuit in the battery management component 140. The sampled voltage value is a voltage on the load, and is measured by a voltage sampling circuit in the battery management component 140.

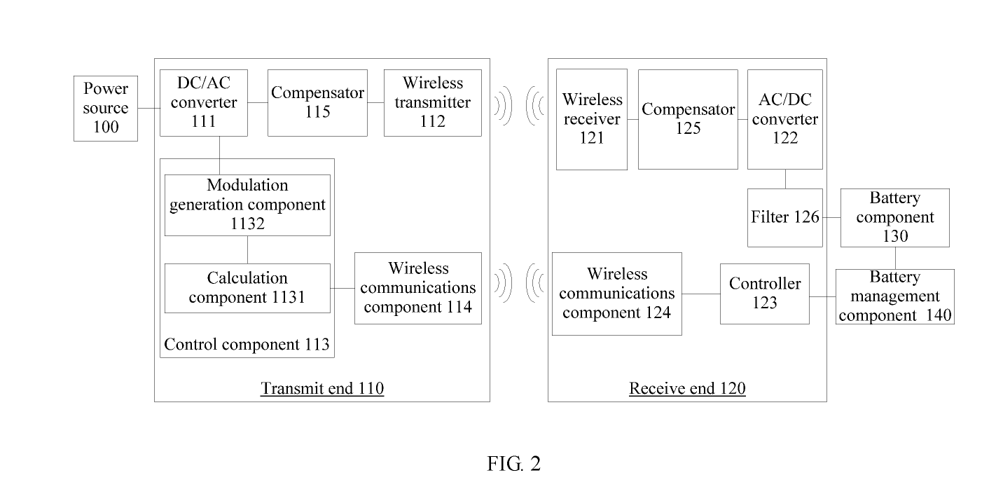

In one embodiment, as shown in FIG. 2, a wireless charging circuit that is applied to the transmit end in the wireless charging system may further include a compensator 115, and the control component 113 includes a calculation component 1131 and a modulation generation component 1132.

The compensator 115 is located between the DC/AC converter 111 and the wireless transmitter 112. The compensator 115 is configured to compensate for the high-frequency alternating current voltage output by the DC/AC module 111, and output the stable high-frequency alternating current voltage to the wireless transmitter 112.

The calculation component 1131 is configured to generate a first control instruction based on the charging parameters when the required voltage value is less than the sampled voltage value or the required current value is less than the sampled current value; or generate a second control instruction based on the charging parameters when the required voltage value is greater than the sampled voltage value or the required current value is greater than the sampled current value.

The modulation generation component 1132 is configured to generate the first drive signal according to the first control instruction generated by the calculation component 1131, and send the first drive signal to the DC/AC converter 111; or generate the second drive signal according to the second control instruction generated by the calculation component 1131, and send the second drive signal to the DC/AC converter 111.

In one embodiment, the modulation generation component 1132 is any one of a pulse width modulation (Pulse Width Modulation, PWM) control component, a frequency modulation control component, and a phase-shift control component.

In one embodiment, as shown in FIG. 2, a wireless charging circuit that is applied to the receive end in the wireless charging system may further include a compensator 125 and a filter 126.

The compensator 125 is located between the wireless receiver 121 and the AC/DC converter 122, and the filter 126 is located behind the AC/DC converter 122.

The compensator 125 is configured to compensate for the direct current voltage output by the AC/DC converter 122, and output the stable direct current voltage to the battery component 130.

The filter 126 is configured to remove a high-frequency voltage from the direct current voltage.

In the foregoing wireless charging circuit that is applied to the transmit end in the wireless charging system, when the DC/AC converter is in the working state under control of the first drive signal, the DC/AC converter converts the direct current voltage into the high-frequency alternating current voltage, namely, the wireless charging system is in the working state; or when the DC/AC converter is in the non-working state under control of the second drive signal, the DC/AC converter does not convert the direct current voltage, namely, the wireless charging system is in the non-working state. The transmit end controls, by using the first drive signal and the second drive signal, the DC/AC converter to switch between the working state and the non-working state, so that the DC/AC converter intermittently works.

A sum of the duration of the first drive signal and the duration of the second drive signal is one intermittent working period of the DC/AC converter. In other words, the sum of the first duration and the second duration is equal to one intermittent working period of the DC/AC converter. A quotient of the duration of the first drive signal divided by the duration of the second drive signal is equal to a quotient of the required power of the load of the receive end divided by an actual power that is of the receive end when the DC/AC converter is in the working state, and the required power is a power that is required by the load in the charging process.

In one embodiment, the actual power that is of the receive end when the DC/AC converter is in the working state may be obtained through calculation by the battery management component based on the battery status, or may be obtained through calculation by the calculation component of the transmit end based on the charging parameters.

In one embodiment, at the transmit end in the wireless charging system, the DC/AC converter is a bridge structure including switching transistors. In one embodiment, the DC/AC converter is a full-bridge structure or a half-bridge structure including switching transistors.

The modulation generation component is configured to send the first drive signal that lasts for the first duration to the DC/AC converter. When the DC/AC converter switches from the non-working state to the working state under control of the first drive signal, a fundamental wave of the high-frequency alternating current voltage and a phase-shift angle between voltages of a front bridge arm and a rear bridge arm of the DC/AC converter linearly increase from zero to a pre-determined value, where the pre-determined value is an angle that enables the DC/AC converter to implement soft switching.

When the DC/AC converter switches from the non-working state to the working state, the fundamental wave of the high-frequency alternating current voltage and the phase-shift angle between the voltages of the front bridge arm and the rear bridge arm of the DC/AC converter linearly increase from zero to the pre-determined value. Therefore, a current on the wireless transmitter linearly increases.

Alternatively, the modulation generation component is configured to send the second drive signal that lasts for the second duration to the DC/AC converter. When the DC/AC converter switches from the working state to the non-working state under control of the second drive signal, a fundamental wave of the high-frequency alternating current voltage and a phase-shift angle between voltages of a front bridge arm and a rear bridge arm of the DC/AC converter linearly decrease from a pre-determined value to zero, where the pre-determined value is an angle that enables the DC/AC converter to implement soft switching.

When the DC/AC converter switches from the working state to the non-working state, the fundamental wave of the high-frequency alternating current voltage and the phase-shift angle between the voltages of the front bridge arm and the rear bridge arm of the DC/AC converter linearly decrease from the pre-determined value to zero. Therefore, a current on the wireless transmitter linearly decreases.

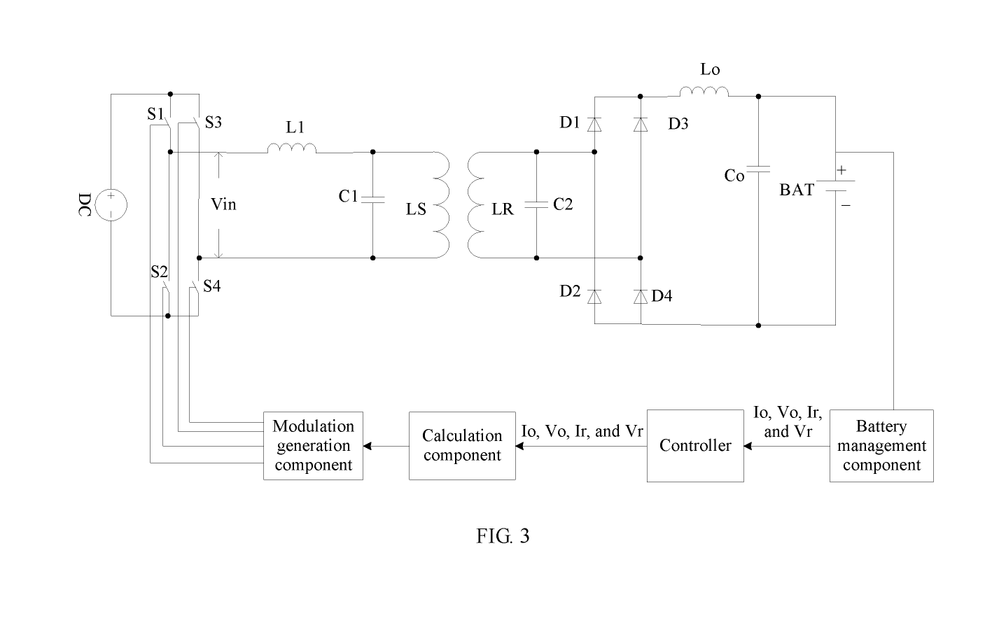

As shown in FIG. 3, for example, a DC/AC converter of a transmit end in a wireless charging system is a full-bridge structure including four power switching transistors, a compensator includes an inductor and a capacitor, and a wireless transmitter is a transmit coil; a wireless receiver of a receive end is a receive coil, a compensator includes a capacitor, an AC/DC converter is a rectifier bridge including four diodes, and a filter includes an inductor and a capacitor.

A power source is a direct current voltage DC. The direct current voltage may be fixed or may be variable.

At the transmit end, the DC/AC converter is the full-bridge structure including the power switching transistors S1 to S4; the compensator includes the inductor L1 and the capacitor C1; the wireless transmitter is an inductor LS; a calculation component generates a first control instruction or a second control instruction; and a modulation generation component generates a first drive signal according to the first control instruction and sends the first drive signal to the DC/AC converter, generates a second drive signal according to the second control instruction and sends the second drive signal to the DC/AC converter, and controls statuses of the power switching transistors S1 to S4 in the DC/AC converter by using the first drive signal and the second drive signal.

The calculation component calculates an error based on a required value and a sampled value of charging parameters, where Error=Required value−Sampled value, and sends the calculated error to a proportional integral (Proportional Integral, PI) controller in the calculation component. The PI controller outputs a value of a duty cycle, limits the value of the duty cycle between 0 and 1, and multiplies the duty cycle by an intermittent working period to obtain working-state duration of the DC/AC converter, namely, first duration. Duration of the second drive signal is the intermittent working period minus the duration of the first drive signal. In other words, the second duration is equal to the intermittent working period minus the first duration. The intermittent working period is a preset value, for example, 10 milliseconds.

When the modulation generation component sends the first drive signal, the DC/AC converter is in the working state. In this case, the first switching transistor S1 and the fourth switching transistor S4 are in an on state, and the second switching transistor S2 and the third switching transistor S3 are in an off state; or the first switching transistor S1 and the fourth switching transistor S4 are in an off state, and the second switching transistor S2 and the third switching transistor S3 are in an on state.

When the modulation generation component sends the second drive signal, the DC/AC converter is in the non-working state. In this case, the first switching transistor S1 and the third switching transistor S3 are in an on state, and the second switching transistor S2 and the fourth switching transistor S4 are in an off state; or the first switching transistor S1 and the third switching transistor S3 are in an off state, and the second switching transistor S2 and the fourth switching transistor S4 are in an on state.

In other words, when the first switching transistor S1 and the fourth switching transistor S3 are in a first state, and the second switching transistor S2 and the third switching transistor S3 are in a second state, the DC/AC converter is in the working state; and when the first switching transistor S1 and the third switching transistor S3 are in the first state, and the second switching transistor S2 and the fourth switching transistor S4 are in the second state, the DC/AC converter is in the non-working state, where the first state is the on state, and the second state is the off state; or the first state is the off state, and the second state is the on state.

At the receive end, the wireless receiver is LR, the compensator comprises the capacitor C2, the AC/DC converter is the diode rectifier bridge including the four diodes, and the filter is the inductor Lo and the capacitor Co.

The receive end is connected to a battery component BAT, and the battery component BAT is connected to a battery management component. The battery management component detects a battery status of the battery component in a charging process, measures a sampled current value by using a current sampling circuit, measures a sampled voltage value by using a voltage sampling circuit, and calculates a required voltage value and a required current value based on the battery status.

When the DC/AC converter of the transmit end is in the working state, the transmit end transmits a high-frequency magnetic field, and the receive end receives the high-frequency alternating current magnetic field transmitted by the transmit end. Because there is a specific distance between the receive end and the transmit end, the high-frequency alternating current magnetic field received by the receive end is related to the distance between the receive end and the transmit end. A smaller distance indicates a larger received high-frequency alternating current magnetic field, and a larger distance indicates a smaller received high-frequency alternating current magnetic field. The receive end converts the received high-frequency alternating current magnetic field into a direct current voltage, to charge the battery component BAT. The battery management component detects the battery status of the battery component BAT, measures the sampled voltage value and the sampled current value, and calculates the required voltage value and the required current value. The battery management component sends the sampled voltage value and the required voltage value to the controller, or sends the sampled current value and the required current value to the controller, or sends the sampled voltage value, the sampled current value, the required voltage value, and the required current value to the controller. The controller receives charging parameters sent by the battery management component, and feeds back the charging parameters to the transmit end. The calculation component of the transmit end generates the first control instruction or the second control instruction based on the charging parameters. The modulation generation component generates the first drive signal according to the first control instruction or generates the second drive signal according to the second control instruction, uses the first drive signal to control the DC/AC converter to be in the working state, or uses the second drive signal to control the DC/AC converter to be in the non-working state, so that the DC/AC converter intermittently works, thereby effectively adjusting an output power of the transmit end, and further making an average power of load of the receive end equal to or close to a required power of the load.

In one embodiment, the AC/DC converter is a synchronous rectification circuit including complementary metal oxide semiconductor (Complementary Metal Oxide Semiconductor, CMOS) transistors.

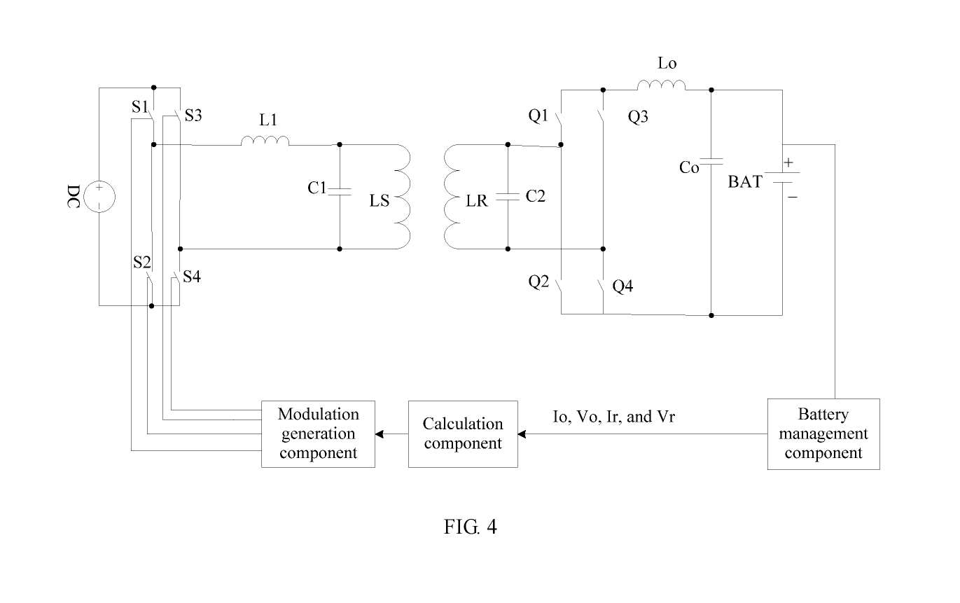

In the wireless charging system shown in FIG. 3, in a wireless charging circuit applied to the receive end, the AC/DC converter is the rectifier bridge structure including the four diodes. Because the diodes have high conduction voltage drop and a large conduction loss, controllable switches may be used to replace the diodes, to implement a synchronous rectification function and improve efficiency. In other words, as shown in FIG. 4, the four diodes in FIG. 3 are replaced by four controllable switches Q1 to Q4.

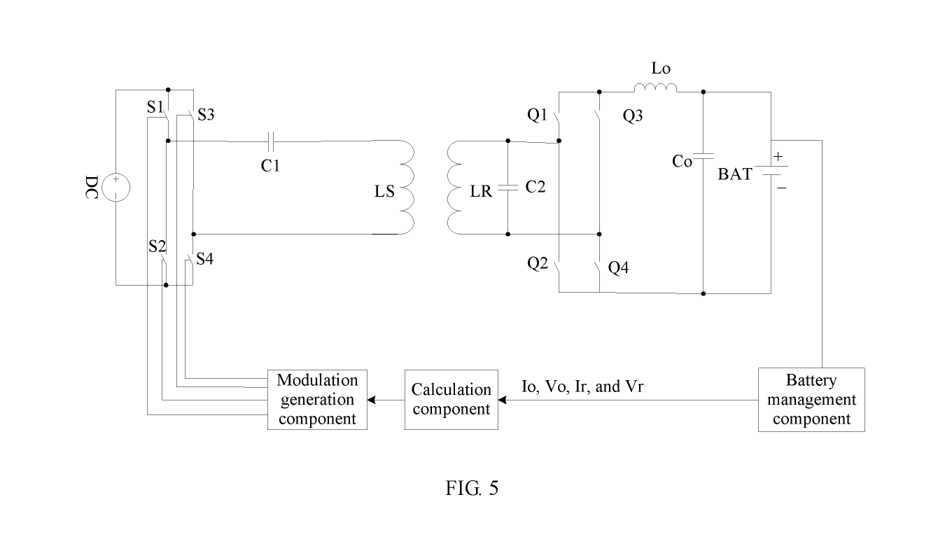

Further, in the wireless charging system, in addition to a structure shown in FIG. 3 and FIG. 4, the compensator of the transmit end and the compensator of the receive end may be alternatively another structure including an inductor and a capacitor, for example, a parallel structure including an inductor and a capacitor, or a series structure including an inductor and a capacitor, or a series-parallel structure including an inductor, an inductor, and a capacitor, or a series-parallel structure including an inductor, a capacitor, and a capacitor. Further, a structure of the compensator of the transmit end may be the same as or different from that of the compensator of the receive end. FIG. 5 is a schematic structural diagram of a wireless charging circuit in another wireless charging system.

It should be noted that, an AC/DC converter of a receive end in FIG. 5 may also be a rectifier bridge structure including four diodes.

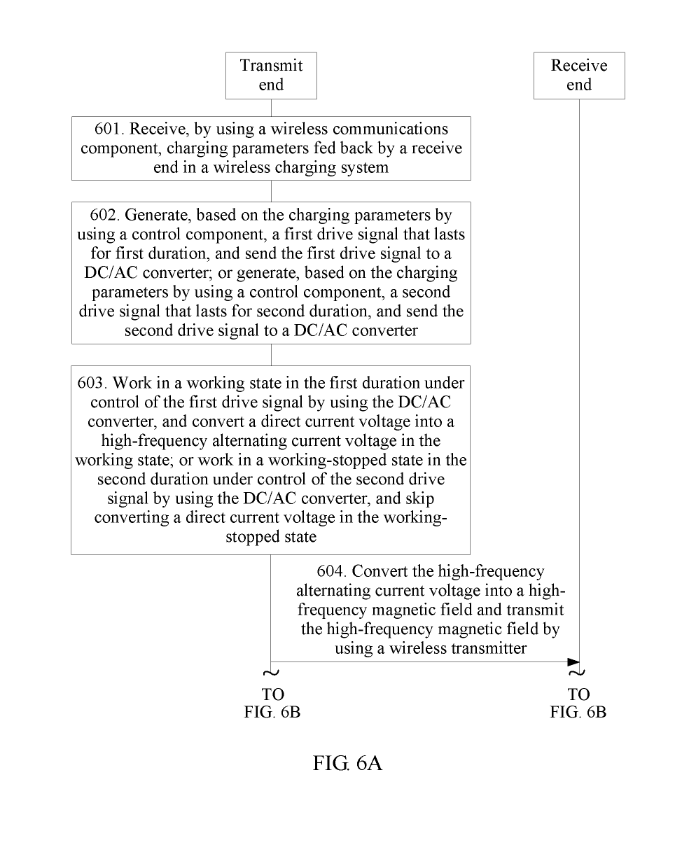

FIG. 6A and FIG. 6B are a flowchart of an example of a wireless charging circuit control method according to the present application. The flowchart of the wireless charging circuit control method is applicable to the transmit end and the receive end in the wireless charging system shown in FIG. 1 or FIG. 2. The wireless charging circuit control method includes the following operations.

Operation 601: The transmit end receives, by using a wireless communications component, charging parameters fed back by the receive end in the wireless charging system.

The charging parameters are used to represent a difference between an actual charging parameter and a required charging parameter.

The transmit end transmits a high-frequency magnetic field by using a wireless transmitter. After receiving the high-frequency magnetic field, the receive end converts the high-frequency magnetic field into a direct current voltage, to charge a battery component. The receive end feeds back, to the transmit end, the charging parameters that are obtained by a battery management component in a charging process of the battery component. The transmit end receives the charging parameters by using the wireless communications component.

Operation 602: The transmit end generates, based on the charging parameters by using a control component, a first drive signal that lasts for first duration, and sends the first drive signal to a DC/AC converter; or generates, based on the charging parameters by using a control component, a second drive signal that lasts for second duration, and sends the second drive signal to a DC/AC converter.

Operation 603: The transmit end works in a working state in the first duration under control of the first drive signal by using the DC/AC converter, and converts a direct current voltage into a high-frequency alternating current voltage in the working state; or works in a non-working state in the second duration under control of the second drive signal by using the DC/AC converter, and skips converting a direct current voltage in the non-working state.

A power source provides the transmit end with the direct current voltage. The direct current voltage may be fixed or may be variable.

When the DC/AC converter is in the working state, the DC/AC converter converts the direct current voltage into the high-frequency alternating current voltage. When the DC/AC converter is in the non-working state, the DC/AC converter does not convert the direct current voltage.

When the DC/AC converter is in the working state, the wireless charging system is in the working state, and when the DC/AC converter is in the non-working state, the wireless charging system is in the non-working state. The DC/AC converter intermittently works under control of the first drive signal and the second drive signal, so that the wireless charging system also intermittently works.

Operation 604: The transmit end converts the high-frequency alternating current voltage into a high-frequency magnetic field and transmits the high-frequency magnetic field, by using a wireless transmitter.

Operation 605: The receive end receives, by using a wireless receiver, the high-frequency magnetic field transmitted by the transmit end in the wireless charging system, and converts the high-frequency magnetic field into a high-frequency alternating current voltage.

Operation 606: The receive end converts the high-frequency alternating current magnetic field into a direct current voltage by using an AC/DC converter, to charge a connected battery component.

Operation 607: The receive end receives, by using a controller, the charging parameters that are generated by a battery management component based on a battery status of the battery component, and sends the charging parameters to the wireless communications component.

Operation 608: The receive end feeds back the charging parameters to the transmit end by using the wireless communications component.

Operation 601 to operation 604 may be separately implemented as a method embodiment of the transmit end, and operation 605 to operation 608 may be separately implemented as a method embodiment of the receive end.

To sum up, according to the wireless charging circuit control method provided in this embodiment of the present application, the transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

FIG. 7A-1 and FIG. 7A-2 are a flowchart of an example of a wireless charging circuit control method according to the present application. The flowchart of the wireless charging circuit control method is applicable to the transmit end and the receive end in the wireless charging system shown in FIG. 1 or FIG. 2. The wireless charging circuit control method includes the following operations.

Operation 701: The transmit end receives, by using a wireless communications component, charging parameters fed back by the receive end in the wireless charging system.

The charging parameters are used to represent a difference between an actual charging parameter and a required charging parameter.

The transmit end transmits a high-frequency magnetic field by using a wireless transmitter. After receiving the high-frequency magnetic field, the receive end converts the high-frequency magnetic field into a direct current voltage, to charge a battery component. The receive end feeds back, to the transmit end, the charging parameters that are obtained by a battery management component in a charging process of the battery component. The transmit end receives the charging parameters by using the wireless communications component.

The charging parameters include a required voltage value, a required current value, a sampled current value, and a sampled voltage value. The required voltage value is a voltage value that is required by load of the receive end in the charging process, for example, a voltage reference value in a constant-voltage charging mode. The required current value is a current value that is required by the load of the receive end in the charging process, for example, a current reference value in a constant-current charging mode, an average current, or a peak current. The sampled current value is a current that passes through the load, and is measured by a current sampling circuit in the battery management component. The sampled voltage value is a voltage on the load, and is measured by a voltage sampling circuit in the battery management component.

Operation 702: The transmit end generates, based on the charging parameters by using a control component, a first drive signal that lasts for first duration, and sends the first drive signal to a DC/AC converter; or generates, based on the charging parameters by using a control component, a second drive signal that lasts for second duration, and sends the second drive signal to a DC/AC converter.

Because the DC/AC converter includes four switching transistors, the transmit end sends the first drive signal to the DC/AC converter by using the control component, and uses the first drive signal to control a first switching transistor and a fourth switching transistor to be in a first state, and a second switching transistor and a third switching transistor to be in a second state; or sends the second drive signal to the DC/AC converter by using the control component, and uses the second drive signal to control a first switching transistor and a third switching transistor to be in a first state, and a second switching transistor and a fourth switching transistor to be in a second state. The first state is an on state, and the second state is an off state; or the first state is an off state, and the second state is an on state.

In other words, the transmit end sends the first drive signal to the DC/AC converter by using the control component, and controls the first switching transistor and the fourth switching transistor to be in the on state, and the second switching transistor and the third switching transistor to be in the off state, or controls the first switching transistor and the fourth switching transistor to be in the off state, and the second switching transistor and the third switching transistor to be in the on state; or the transmit end sends the second drive signal to the DC/AC converter by using the control component, and controls the first switching transistor and the third switching transistor to be in the on state, and the second switching transistor and the fourth switching transistor to be in the off state, or controls the first switching transistor and the third switching transistor to be in the off state, and the second switching transistor and the fourth switching transistor to be in the on state.

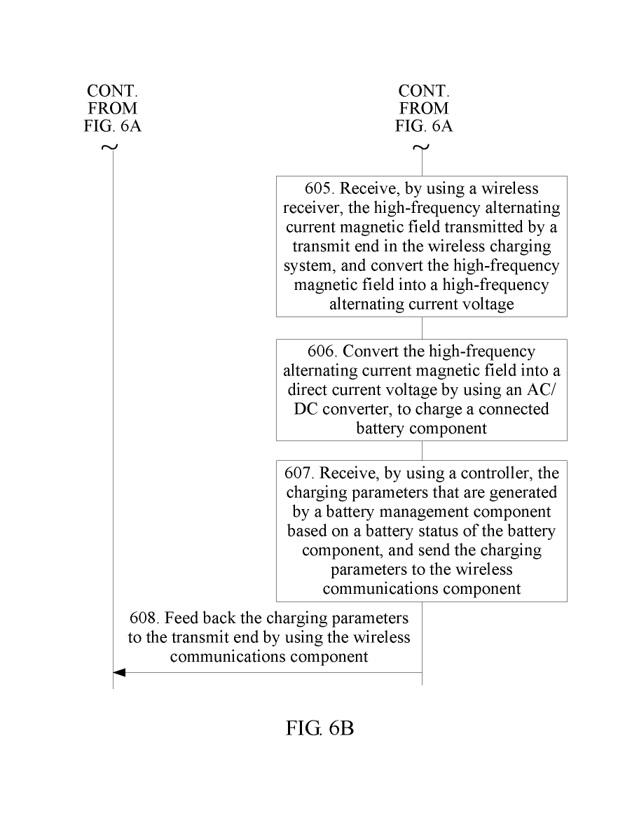

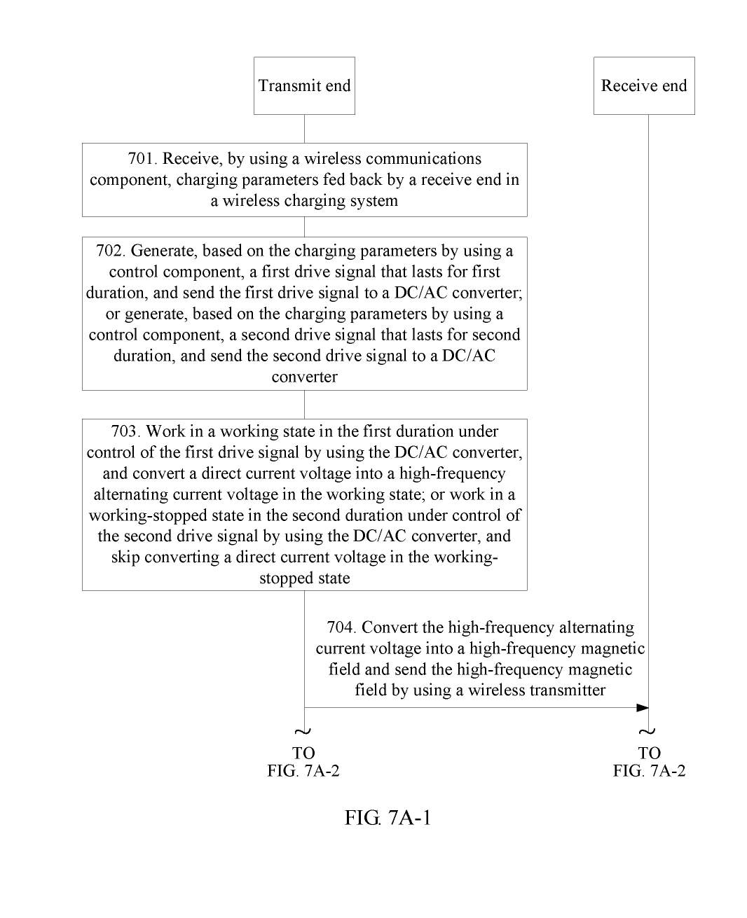

Because the control component includes a calculation component and a modulation generation component, the operation is specifically implemented by the following two operations, as shown in FIG. 7B.

Operation 7021: The transmit end generates a first control instruction based on the charging parameters by using the calculation component when a required voltage value is less than a sampled voltage value or a required current value is less than a sampled current value; or generates a second control instruction based on the charging parameters by using the calculation component when a required voltage value is greater than a sampled voltage value or a required current value is greater than a sampled current value.

The calculation component calculates an error based on a required value, a sampled value, and a formula “Error=Required value−Sampled value”, and sends the calculated error to a PI controller in the calculation component. The PI controller outputs a value of a duty cycle, limits the value of the duty cycle between 0 and 1, and multiplies the duty cycle by an intermittent working period to obtain working-state duration of the DC/AC converter, namely, first duration. Duration of the second drive signal is the intermittent working period minus the duration of the first drive signal. In other words, the second duration is equal to the intermittent working period minus the first duration. The intermittent working period is a value that is manually set in advance, for example, 10 milliseconds.

In one embodiment, a quotient of the first duration divided by the second duration is equal to a quotient of a required power of the load of the receive end divided by an actual power that is of the receive end when the DC/AC converter is in the working state, and the required power is a power that is required by the load in the charging process. The first duration and the second duration can be calculated based on a proportional relationship between the first duration and the second duration and an intermittent working period of the DC/AC converter.

Operation 7022: The transmit end generates the first drive signal according to the first control instruction by using the modulation generation component, and sends the first drive signal to the DC/AC converter; or generates the second drive signal according to the second control instruction by using the modulation generation component, and sends the second drive signal to the DC/AC converter.

Operation 703: The transmit end works in a working state in the first duration under control of the first drive signal by using the DC/AC converter, and converts a direct current voltage into a high-frequency alternating current voltage in the working state; or works in a non-working state in the second duration under control of the second drive signal by using the DC/AC converter, and skips converting a direct current voltage in the non-working state.

A power source provides the transmit end with the direct current voltage. The direct current voltage may be fixed or may be variable.

When the DC/AC converter is in the working state, the DC/AC converter converts the direct current voltage into the high-frequency alternating current voltage, and when the DC/AC converter is in a non-working state, the DC/AC converter does not convert the direct current voltage.

When the DC/AC converter is in the working state, the wireless charging system is in the working state, and when the DC/AC converter is in the non-working state, the wireless charging system is in the non-working state. The DC/AC converter intermittently works under control of the first drive signal and the second drive signal.

In one embodiment, when the DC/AC converter switches from the non-working state to the working state under control of the first drive signal that lasts for the first duration and that is sent by the modulation generation component, a fundamental wave of the high-frequency alternating current voltage and a phase-shift angle between voltages of a front bridge arm and a rear bridge arm of the DC/AC converter linearly increase from zero to a pre-determined value, where the pre-determined value is an angle that enables the DC/AC converter to implement soft switching, so as to control a current on the wireless transmitter to linearly increase.

In one embodiment, when the DC/AC conversion module switches from the working state to the non-working state under control of the second drive signal that lasts for the second duration and that is sent by the modulation generation component, a fundamental wave of the high-frequency alternating current voltage and a phase-shift angle between voltages of a front bridge arm and a rear bridge arm of the DC/AC converter linearly increase from zero to a pre-determined value, so as to control a current on the wireless transmitter to linearly decrease.

Detailed descriptions are provided by using the wireless charging circuit of the transmit end in the wireless charging system shown in FIG. 3.

Because the wireless charging system is an underdamped system and is vulnerable to flapping, soft start-up and soft turn-off are needed when the wireless charging system switches between the working state and the non-working state.

In FIG. 3, the DC/AC converter is an H-bridge structure including diodes, and functions to convert the direct current voltage DC into a high-frequency alternating current voltage Vin. When parameters of L1, C1, and LS are properly selected, a current of the transmit coil LS is a controlled current source in direct proportion to a fundamental wave of the high-frequency alternating current voltage Vin, and the fundamental wave amplitude of the high-frequency alternating current voltage Vin is in direct proportion to a phase-shift angle σ (σ∈[0,π]) between voltages (drive pulses) of a front bridge arm and a rear bridge arm of the H bridge. In a relatively narrow range in which the phase-shift angle is close to π, all switching transistors of the H bridge are in a soft switching state.

When the DC/AC converter is in the working state, the phase-shift angle is an angle that keeps soft switching of the H bridge. For example, the angle that keeps soft switching of the H bridge is 165 degrees. When the DC/AC converter is in the non-working state, the phase-shift angle is 0 or close to 0.

Soft switching cannot be implemented in a soft start-up process or a soft turn-off process, and system efficiency is low. Therefore, duration of a switching process should be as short as possible. The phase-shift angle σ and the current of the transmit coil LS are in a non-linear relationship, and a gain is unstable. Therefore, the duration of the switching process may be shortened by using a method of compensating for the phase-shift angle. In one embodiment, a manner such as a single slope linear processing or piecewise linear processing may be used to enable the phase-shift angle σ to increase at a fixed speed, namely, enable the phase-shift angle σ to linearly change, so that the current of the transmit coil LS can also linearly change.

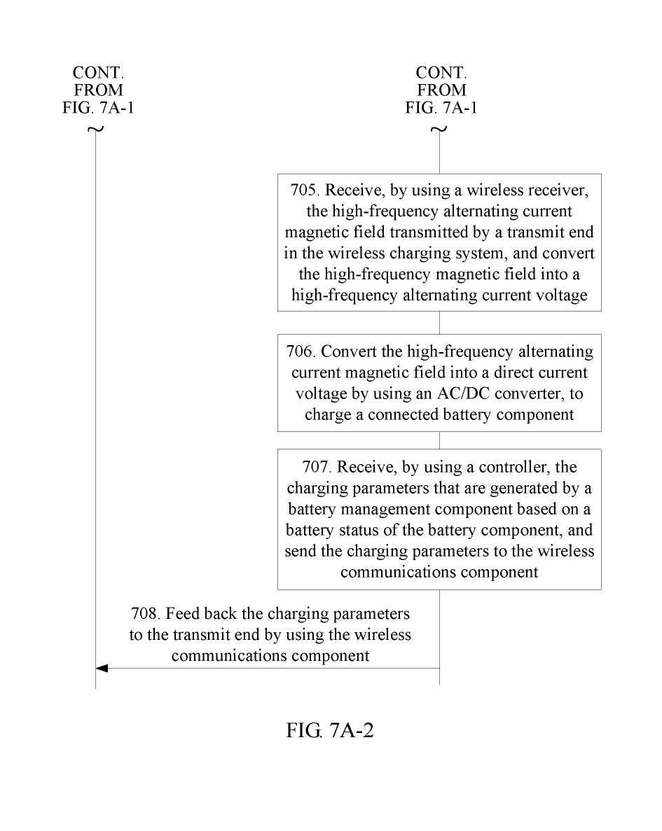

For the soft start-up process, a relationship between the phase-shift angle σ and the current I of the transmit coil LS is shown in FIG. 8. After the phase-shift angle σ changes from 0 to be close to an angle that keeps soft start-up of the H bridge, a time for the phase-shift angle σ to increase to the angle that keeps soft start-up of the H bridge is very long. To be specific, a change rule between the phase-shift angle σ and the time is nonlinear. For example, assuming that the angle that keeps soft start-up of the H bridge is π, it takes 0.001 s for the phase-shift angle σ to change from 0 to an angle close to π, and it takes 0.005 s for the phase-shift angle σ to change from the angle close to π to π.

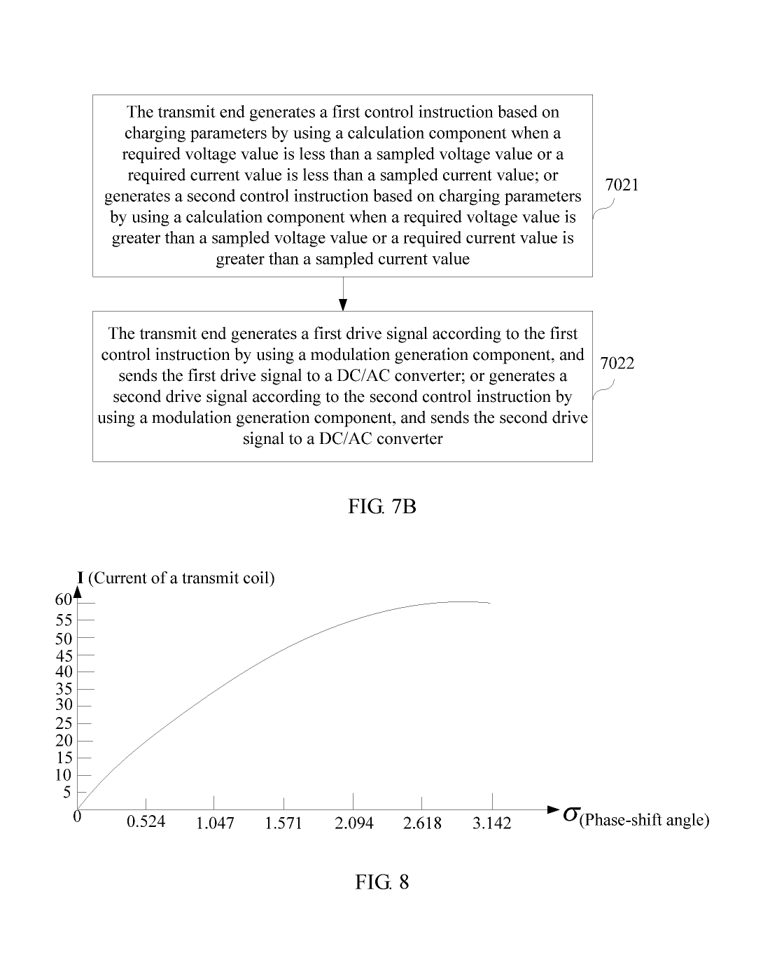

For this problem, in the soft start-up process, the phase-shift angle σ may be approximately linearly increased from 0 to a specified value. In other words, in the soft start-up process, the phase-shift angle σ is enabled to linearly change, thereby enabling the current to linearly increase and implementing fast soft start-up. Correspondingly, in the soft turn-off process, the phase-shift angle σ is approximately linearly decreased from the specified value to 0, thereby enabling the current to linearly decrease and implementing fast soft turn-off. The current linearly increases or linearly decreases, so that a loss of the circuit during soft start-up and soft turn-off is decreased. FIG. 9 schematically shows a changing process of the phase-shift angle in the soft start-up process, a normal working process, and the soft turn-off process after compensation processing is performed.

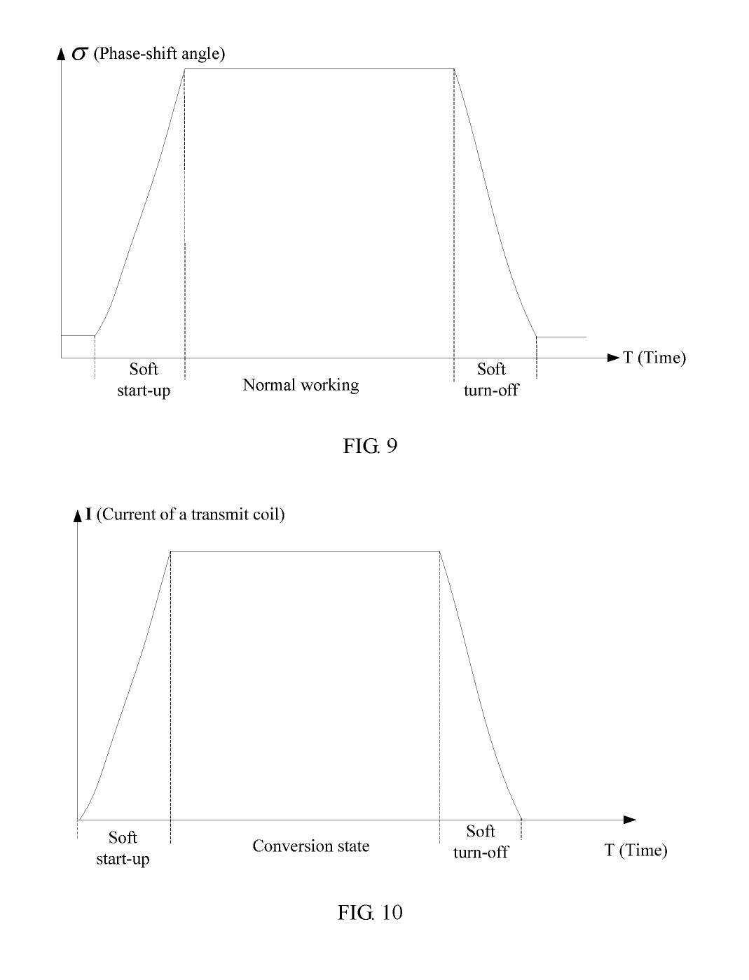

Linear compensation is performed on the phase-shift angle σ. The current can still fast increase after the phase-shift angle σ reaches the angle that keeps soft switching of the H bridge, so that the current of the transmit coil can keep linearly increasing when the DC/AC converter switches from the non-working state to the working state; and the current can fast decrease when the phase-shift angle σ decreases from the specified value to the angle that keeps soft switching of the H bridge, so that the current of the transmit coil can keep linearly decreasing when the DC/AC converter switches from the working state to the non-working state. FIG. 10 schematically shows a changing process of the current of the transmit coil in the soft start-up process, the working state, and the soft turn-off process after linear processing.

Operation 704: The transmit end converts the high-frequency alternating current voltage into a high-frequency magnetic field and sends the high-frequency magnetic field, by using a wireless transmitter.

Operation 705: The receive end receives, by using a wireless receiver, the high-frequency alternating current magnetic field transmitted by the transmit end in the wireless charging system, and converts the high-frequency magnetic field into a high-frequency alternating current voltage.

Operation 706: The receive end converts the high-frequency alternating current magnetic field into a direct current voltage by using an AC/DC converter, to charge a connected battery component.

Before the connected battery component is charged, the receive end compensates, by using a compensator, for the direct current voltage output by the AC/DC converter, removes a high-frequency voltage from the direct current voltage by using a filter, and outputs the stable direct current voltage to the battery component, to charge the battery component.

Operation 707: The receive end receives, by using a controller, the charging parameters that are generated by a battery management component based on a battery status of the battery component, and sends the charging parameters to the wireless communications component.

The charging parameters include a required voltage value, a required current value, a sampled current value, and a sampled voltage value.

During charging of the battery component, the battery management component detects the battery status of the battery component, and generates the charging parameters. The battery management component sends the charging parameters to the controller of the receive end, and then the controller of the receive end sends the charging parameters to the wireless transmitter.

In one embodiment, the charging parameters sent by the battery management component to the controller are the required voltage value and the sampled voltage value, or the required current value and the sampled current value, or the required voltage value, the required current value, the sampled current value, and the sampled voltage value.

Operation 708: The receive end feeds back the charging parameters to the transmit end by using the wireless communications component.

Operation 701 to operation 704 may be separately implemented as a method embodiment of the transmit end, and operation 705 to operation 708 may be separately implemented as a method embodiment of the receive end.

To sum up, according to the wireless charging circuit control method provided in this embodiment of the present application, the transmit end provides the receive end with the high-frequency alternating current magnetic field; the receive end receives the high-frequency alternating current magnetic field and then converts the high-frequency alternating current magnetic field into the direct current voltage to charge the battery component; the receive end feeds back the charging parameters to the transmit end; the receive end generates, based on the received charging parameters, the first drive signal that lasts for the first duration or the second drive signal that lasts for the second duration, and sends the first drive signal or the second drive signal to the DC/AC converter, so that the DC/AC converter intermittently works under control of the first drive signal and the second drive signal; and the DC/AC converter converts the direct current voltage into the high-frequency alternating current magnetic field under control of the first drive signal, and the wireless charging system has an output power, or the DC/AC converter does not convert the direct current voltage under control of the second drive signal, and the wireless charging system has no output power. A working time of the DC/AC converter is controlled, so that the system switches between the normal working state and the non-working state without adding an additional circuit, thereby resolving a problem that circuit costs and a volume are increased in a prior-art output power adjustment method, and achieving effects of making an average power of actual load of the receive end equal to or close to a required power of the load, improving efficiency of the wireless charging system, and improving power density of the wireless charging system.

Further, when the DC/AC converter switches between the working state and the non-working state, a current keeps linearly increasing or linearly decreasing, so that impact on the wireless charging system in the switching process is reduced, a soft switching process is quickened, and a loss in the switching process is reduced.

In addition, when the DC/AC converter implements soft switching, the average power of the actual load of the receive end is greater than the required power of the load. Therefore, the DC/AC converter switches between the working state and the non-working state, so that the average power of the actual load of the receive end is equal to or close to the required power of the load when the DC/AC converter implements soft switching.

A person of ordinary skill in the art may be aware that, units and algorithm operations in examples described with reference to the embodiments disclosed in this specification may be implemented by electronic hardware or a combination of computer software and electronic hardware. Whether the functions are performed by hardware or software depends on particular applications and design constraints of the technical solutions.

It may be clearly understood by a person of ordinary skill in the art that, for ease and brevity of description, for a detailed working process of the foregoing apparatus and unit, reference may be made to a corresponding process in the foregoing method embodiments, and details are not described herein again.

In the embodiments provided in this application, it should be understood that the disclosed circuit and method may be implemented in other manners. For example, the described apparatus embodiment is merely an example. For example, the unit division may merely be logical function division and may be other division in actual implementation. For example, a plurality of units or components may be combined or may be integrated into another system, or some features may be ignored or not performed.

The units described as separate parts may or may not be physically separate, and parts displayed as units may or may not be physical units, may be located in one position, or may be distributed on a plurality of network units. Some or all of the units may be selected depending on actual requirements to achieve the objectives of the solutions of the embodiments.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A wireless charging circuit comprising:
a direct current (DC)/alternating current (AC) converter connected to a power source;
a wireless transmitter and a control component each connected to the DC/AC converter; and a wireless communications component connected to the control component, wherein
the power source is configured to provide a direct current voltage;
the wireless communications component is configured to receive charging parameters fed back by a receive end in a wireless charging system, wherein the charging parameters are used to represent a difference between an actual charging parameter and a required charging parameter;
the control component is configured to generate, based on the charging parameters, a first drive signal that lasts for a first duration, and send the first drive signal to the DC/AC converter or generate, based on the charging parameters, a second drive signal that lasts for a second duration, and send the second drive signal to the DC/AC converter;
the DC/AC converter is configured to be in a working state in the first duration under control of the first drive signal, and convert the direct current voltage into a high-frequency alternating current voltage in the working state or be in a non-working state in the second duration under control of the second drive signal, and skip converting the direct current voltage in the non-working state; and
the wireless transmitter is configured to convert, into a high-frequency magnetic field, the high-frequency alternating current voltage that is obtained through conversion when the DC/AC converter is in the working state, and transmit the high-frequency magnetic field, wherein the high-frequency magnetic field is used to charge a battery component.

2. The wireless charging circuit according to claim 1, wherein the control component comprises a modulation generation component, and the DC/AC converter is a bridge-structure circuit comprising switching transistors; and
the modulation generation component is configured to send the first drive signal that lasts for the first duration to the DC/AC converter, wherein when the DC/AC converter switches from the non-working state to the working state under control of the first drive signal, a fundamental wave of the high-frequency alternating current voltage and a phase-shift angle between voltages of a front bridge arm and a rear bridge arm of the DC/AC converter linearly increase from zero to a pre-determined value, wherein the pre-determined value is an angle that enables the DC/AC converter to implement soft switching; or
the modulation generation component is configured to send the second drive signal that lasts for the second duration to the DC/AC converter, wherein when the DC/AC converter switches from the working state to the non-working state under control of the second drive signal, a fundamental wave of the high-frequency alternating current voltage and a phase-shift angle between voltages of a front bridge arm and a rear bridge arm of the DC/AC converter linearly decrease from a pre-determined value to zero, wherein
the pre-determined value is an angle that enables the DC/AC converter to implement soft switching.

3. The wireless charging circuit according to claim 1, wherein a quotient of the first duration divided by the second duration is equal to a quotient of a required power of load of the receive end divided by an actual power that is of the receive end when the DC/AC converter is in the working state, and the required power is a power that is required by the load in a charging process.

4. The wireless charging circuit according to claim 1, wherein the charging parameters comprise a required voltage value, a required current value, a sampled current value, and a sampled voltage value, and the required voltage value is a voltage value that is required by the load of the receive end in the charging process;
the control component comprises a calculation component and a modulation generation component, and the modulation generation component is any one of a pulse width modulation PWM control component, a frequency modulation control component, or a phase-shift control component;
the calculation component is configured to generate a first control instruction based on the charging parameters when the required voltage value is less than the sampled voltage value or the required current value is less than the sampled current value or generate a second control instruction based on the charging parameters when the required voltage value is greater than the sampled voltage value or the required current value is greater than the sampled current value; and
the modulation generation component is configured to generate the first drive signal according to the first control instruction, and send the first drive signal to the DC/AC converter or is configured to generate the second drive signal according to the second control instruction, and send the second drive signal to the DC/AC converter.

5. The wireless charging circuit according to claim 2, wherein the DC/AC converter comprises four switching transistors;
when a first switching transistor and a fourth switching transistor are in a first state, and a second switching transistor and a third switching transistor are in a second state, the DC/AC converter is in the working state;
when the first switching transistor and the third switching transistor are in the first state, and the second switching transistor and the fourth switching transistor are in the second state, the DC/AC converter is in the non-working state; and
the first state is an on state, and the second state is an off state or the first state is an off state, and the second state is an on state.

6. The wireless charging circuit according to claim 1, further comprising a compensator, and the compensator is located between the DC/AC converter and the wireless transmitter; and
the compensator is configured to compensate for the high-frequency alternating current voltage output by the DC/AC converter, and output a stable high-frequency alternating current voltage to the wireless transmitter.

7. A wireless charging circuit comprising:
a wireless receiver;
an alternating current (AC)/direct current (DC) converter connected to the wireless receiver;
a controller; and
a wireless communications component connected to the controller, wherein
the wireless receiver is configured to receive a high-frequency magnetic field transmitted by a transmit end in a wireless charging system, and convert the high-frequency magnetic field into a high-frequency alternating current voltage;
the AC/DC converter is configured to convert the high-frequency alternating current voltage into a direct current voltage, to charge a connected battery component;
the controller is configured to receive charging parameters that are generated by a battery management component based on a battery status of the battery component, and send the charging parameters to the wireless communications component, wherein the battery management component is connected to the battery component; and
the wireless communications component is configured to feed back the charging parameters to the transmit end, wherein the charging parameters are used to represent a difference between an actual charging parameter and a required charging parameter.

8. The wireless charging circuit according to claim 7, wherein the charging parameters comprise a required voltage value, a required current value, a sampled current value, and a sampled voltage value, the required voltage value is a voltage value that is required by load of the receive end in a charging process, and the required current value is a current value that is required by the load of the receive end in the charging process.

9. The wireless charging circuit according to claim 7, wherein
the AC/DC converter is a rectifier bridge circuit comprising diodes; or
the AC/DC converter is a synchronous rectification circuit comprising complementary metal oxide semiconductor CMOS transistors.

10. The wireless charging circuit according to claim 7, further comprising a compensator, and the compensator is located between the wireless receiver and the AC/DC converter; and
the compensator is configured to compensate for the direct current voltage output by the AC/DC converter, and output a stable direct current voltage to the battery component.

11. The wireless charging circuit according to claim 7, further comprising a filter, and the filter is located behind the AC/DC converter; and
the filter is configured to remove a high-frequency voltage from the direct current voltage.

12. A wireless charging system, wherein the system comprises: a power source, a transmit end connected to the power source, a receive end, a battery component connected to the receive end, and a battery management component connected to both the battery component and the receive end, wherein
the transmit end comprises a wireless charging circuit,
the wireless charging circuit comprising:
a direct current (DC)/alternating current (AC) converter connected to the power source;
a wireless transmitter and a control component each connected to the DC/AC converter; and a wireless communications component connected to the control component, wherein
the power source is configured to provide a direct current voltage;
the wireless communications component is configured to receive charging parameters fed back by the receive end, wherein the charging parameters are used to represent a difference between an actual charging parameter and a required charging parameter;
the control component is configured to generate, based on the charging parameters, a first drive signal that lasts for a first duration, and send the first drive signal to the DC/AC converter or generate, based on the charging parameters, a second drive signal that lasts for a second duration, and send the second drive signal to the DC/AC converter;
the DC/AC converter is configured to be in a working state in the first duration under control of the first drive signal, and convert the direct current voltage into a high-frequency alternating current voltage in the working state or be in a non-working state in the second duration under control of the second drive signal, and skip converting the direct current voltage in the non-working state; and
the wireless transmitter is configured to convert, into a high-frequency magnetic field, the high-frequency alternating current voltage that is obtained through conversion when the DC/AC converter is in the working state, and transmit the high-frequency magnetic field, wherein the high-frequency magnetic field is used to charge a battery component.

13. A wireless charging circuit control method comprising:
receiving, by using a wireless communications component, charging parameters fed back by a receive end in a wireless charging system, wherein the charging parameters are used to represent a difference between an actual charging parameter and a required charging parameter;
generating, based on the charging parameters by using a control component, a first drive signal that lasts for a first duration, and sending the first drive signal to a DC/AC converter or generating, based on the charging parameters by using a control component, the second drive signal that lasts for second duration, and sending the second drive signal to the DC/AC converter;
working in a working state in the first duration under control of the first drive signal by using the DC/AC converter, and converting the direct current voltage into the high-frequency alternating current voltage in the working state or working in a non-working state in the second duration under control of the second drive signal by using the DC/AC converter, and skipping converting the direct current voltage in the non-working state; and
converting, into a high-frequency magnetic field by using a wireless transmitter, the high-frequency alternating current voltage that is obtained through conversion when the DC/AC converter is in the working state, and transmitting the high-frequency magnetic field.

14. The method according to claim 13,
further comprising:
sending the first drive signal that lasts for the first duration to the DC/AC converter by using a modulation generation component, wherein when a DC/AC converter switches from the non-working state to the working state under control of the first drive signal, a fundamental wave of the high-frequency alternating current voltage and a phase-shift angle between voltages of a front bridge arm and a rear bridge arm of the DC/AC converter linearly increase from zero to a pre-determined value, wherein the pre-determined value is an angle that enables the DC/AC converter to implement soft switching; or
sending the second drive signal that lasts for the second duration to the DC/AC converter by using the modulation generation component, wherein when the DC/AC converter switches from the working state to the non-working state under control of the second drive signal, a fundamental wave of the high-frequency alternating current voltage and a phase-shift angle between voltages of a front bridge arm and a rear bridge arm of the DC/AC converter linearly decrease from a pre-determined value to zero, wherein
the pre-determined value is an angle that enables the DC/AC converter to implement soft switching.

15. The method according to claim 13, wherein a quotient of the first duration divided by the second duration is equal to a quotient of a required power of load of the receive end divided by an actual power that is of the receive end when the DC/AC converter is in the working state, wherein the required power is a power that is required by the load in a charging process.

16. The method according to claim 13, wherein the charging parameters comprise a required voltage value, a required current value, a sampled current value, and a sampled voltage value, and the required voltage value is a voltage value that is required by the load of the receive end in the charging process,
the method further comprising:
generating a first control instruction based on the charging parameters by using a calculation component when the required voltage value is less than the sampled voltage value or the required current value is less than the sampled current value or generating a second control instruction based on the charging parameters by using the calculation component when the required voltage value is greater than the sampled voltage value or the required current value is greater than the sampled current value; and
generating the first drive signal according to the first control instruction by using a modulation generation component, and sending the first drive signal to the DC/AC converter or generating the second drive signal according to the second control instruction by using the modulation generation component, and sending the second drive signal to the DC/AC converter.

17. The method according to claim 13,
further comprising:
compensating, by using a compensator, for the high-frequency alternating current voltage output by the DC/AC converter, and outputting a stable high-frequency alternating current voltage to the wireless transmitter.

18. A wireless charging circuit control method comprising:
receiving, by using a wireless receiver, a high-frequency magnetic field transmitted by a transmit end in a wireless charging system, and converting the high-frequency magnetic field into a high-frequency alternating current voltage;
converting the high-frequency magnetic field into a direct current voltage by using an AC/DC module, to charge a connected battery component;
receiving, by using a controller, charging parameters that are generated by a battery management component based on a battery status of the battery component, and sending the charging parameters to a wireless communications component, wherein the battery management component is connected to the battery component; and
feeding back the charging parameters to the transmit end by using the wireless communications component, wherein the charging parameters are used to represent a difference between an actual charging parameter and a required charging parameter.

19. The method according to claim 18, wherein the charging parameters comprise a required voltage value, a required current value, a sampled voltage value, and a sampled current value, the required voltage value is a voltage value that is required by load of the receive end in a charging process, and the required current value is a current value that is required by the load of the receive end in the charging process.

20. The method according to claim 18,
further comprising:
compensating, by using a compensator, for the direct current voltage output by the AC/DC converter, and outputting a stable direct current voltage to the battery component.
